(19) United States
(12) Patent Application Publication
(10) Pub. No.: US 2008/0012932 A1
(43) Pub. Date: Jan. 17, 2008

(54) Image forming apparatus

(75) Inventor: Toshihiro Motoi, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/811,859

(22) Filed: Jun. 11, 2007

(30) Foreign Application Priority Data
Jul. 11, 2006 (JP) 2006-190777

(51) Int. Cl. B41J 2/47

(52) U.S. Cl. 347/234

(57) ABSTRACT

An image forming apparatus to form a color image by using a plurality of laser units, each simultaneously scanning a plurality of scanning lines in a main scanning direction to write with laser beams emitted from a plurality of laser light sources. The apparatus includes: a control unit to control each of the laser units, which includes a reference laser light source and another laser light source, such that, while the laser light sources are synchronized with a clock, a write-start position of a laser beam emitted from the another laser light source is matched with a reference write-start position of a laser beam emitted from the reference laser light source, wherein the control unit selects in advance the reference laser light source in every laser units, based on a previously measured displacement between the plurality of laser beams in each of the laser units.

### BACKGROUND OF THE INVENTION

1. Field of the Invention

The present invention relates to an image forming apparatus and more particularly to an image forming apparatus capable of simultaneously scanning a plurality of scanning lines by a plurality of laser light sources.

2. Description of Related Art

Recently, in image forming apparatuses such as printers and copiers, a multi-beam type laser unit has been used in order to achieve high-speed and high resolution printing, in which a semiconductor laser array having a plurality of laser light sources emits a plurality of beams to simultaneously scan a plurality of scanning lines for writing. In such an image forming apparatus, when the laser unit has two laser light sources, for example, the two laser light sources are arranged in a direction perpendicular to a main scanning direction, namely, in a sub-scanning direction (vertical arrangement), or arranged with an inclination having a certain angle with respect to the sub-scanning direction (inclined arrangement). When two laser light sources are used with the inclined arrangement, the inclination angle is usually so adjusted that two laser lights are displaced to each other by one pixel in the main scanning direction.

When forming an image, while two laser light sources are synchronized with a clock by using one of the light sources, respective data are simultaneously sent to the two laser light sources in case of the vertical arrangement, and in case of the inclined arrangement, data are sent to a second laser light source with a delay of one pixel to compensate the shift of laser beams emitted from the two laser light sources in the main scanning direction, to resultantly form an image with no shift of write-start positions in the main scanning direction. However, the angle of the two laser light sources with respect to the sub-scanning direction actually has a mounting error less than one pixel. That is, in case of the vertical arrangement, a mounting error of the light sources are directly reflected, and in case of the inclined arrangement, the shift less than one pixel in the main scanning direction is not cancelled even if emission timings of the laser light sources are controlled so as to compensate by one pixel in the main scanning direction.

Such shift in the main scanning direction causes a remarkable so-called color displacement (position misalignment) when a color image is formed by using a plurality of laser units corresponding to a plurality of toners of, e.g., black (K), cyan (C), magenta (M) and yellow (Y) colors. Generally, the displacements in the main scanning direction differ from one another among laser units of respective colors. For instance, as shown in FIG. 7, when a black (K) laser unit is used as a reference of adjustment for color displacement while a laser light source LD1 of each color is used for synchronization, it is assumed that a second laser light source LD2 in the black (K) laser unit is displaced relative to the first laser light source LD1 by +⅓ pixel in the main scanning direction shown by an arrow X in the drawing. Using the black (K) laser unit having such a displacement, for example, a magenta (M) laser unit is adjusted according to a usual adjustment method so that the write-start position of each first laser light source LD1 matches to that of the black one.

At this time, since the magenta (M) laser unit has an innate displacement, write-start positions of second laser light sources LD2 of respective black (K) and magenta (M) laser units are displaced according to the innate displacements of the magenta (M) unit as shown in FIG. 8A to FIG. 8E. FIG. 8E shows a color displacement of one pixel. FIGS. 7 and 8 show displacements after compensation in case of the inclined arrangement. In FIGS. 8A to 8E, numbers written at the right side indicate various innate displacements of the magenta (M) unit.

Various apparatus and methods have been proposed to solve such color displacement. For example, the frequency of a video clock, commonly used to each laser unit, is possible to be changed for at least one laser unit, the displacement in the main scanning direction has been reduced by delaying a synchronization signal, or an adjusting part is provided for adjusting an inclination angle of a laser array (see, JP 2000-218858A and JP 2002-189A).

However, such a conventional apparatus requires a PLL (phase-locked loop) circuit for variable control of the frequency of the video clock, or a delay circuit for delaying the synchronization signal, which requires a control circuit to be complicated. In other case, an adjusting part for adjusting the inclination angle of a laser array and a control circuit thereof are newly required. Further, by providing the PLL circuit, the delay circuit or the adjusting part renders, such an image forming apparatus becomes more expensive.

### SUMMARY OF THE INVENTION

An object of the invention is to enable image formation without a remarkable color displacement by using an existing control circuit synchronized with a clock without newly providing a control circuit or an adjusting part.

In order to achieve the above object, an image forming apparatus reflecting one aspect of the present invention, to form a color image by using a plurality of laser units, each simultaneously scanning a plurality of scanning lines in a main scanning direction to write with laser beams emitted from a plurality of laser light sources, comprises:

a control unit to control each of the plurality of laser units, which includes a reference laser light source and another laser light source, such that, while the plurality of laser light sources are synchronized with a clock, a write-start position of a laser beam emitted from the another laser light source is matched with a reference write-start position of a laser beam emitted from the reference laser light source,

wherein the control unit selects in advance the reference laser light source in every laser units, based on a previously measured displacement between the plurality of laser beams in each of the laser units.

Preferably, when a plus/minus of the displacement in each of the laser units is the same as that of a displacement in a particular laser unit which is a reference unit for adjustment of a color displacement in a color image, based on the previously measured displacement of the laser beams in each of the laser units, the control unit selects in advance the same laser light source as the reference laser light source of the particular laser unit, as the reference laser light source, and when a plus/minus of the displacement in the laser unit is different from that of a displacement in a particular laser unit selected from the plurality of laser units, the control unit selects in advance a laser light source different from the reference laser light source of the particular laser unit, as the reference laser light source.

Preferably, the displacement between the plurality of laser beams in each of the laser units is an innate displacement of each laser unit.

Preferably, the innate displacement of each laser unit is a displacement of less than one pixel in the main scanning direction of laser beams emitted from the plurality of laser light sources in the each laser unit.

Preferably, the control unit includes a memory unit which stores in advance displacement data of less than one pixel in the main scanning direction of a laser beam emitted from the another laser light source.

Preferably, the control unit reads out from the memory unit the displacement data for each laser unit and selects in advance the reference laser light source based on the displacement data.

Preferably, the laser unit comprises the plurality of laser light sources with inclined arrangement such that the plurality of laser beams irradiate positions displaced in the main scanning direction in a pixel unit.

Preferably, the plurality of laser light sources comprise two laser light sources.

Preferably, the control unit controls each of the plurality of laser units to match the write-start position of the laser beam emitted from the another laser light source with the reference write-start position of a laser beam emitted from the reference laser light source, by the another laser light source irradiating a position delayed by a displaced pixel in the scanning direction with respect to a laser beam emitted from the reference laser light source, at a timing delayed by the displaced pixel from the reference laser light source.

Preferably, the laser unit comprises the plurality of laser light sources with inclined arrangement such that the two laser light sources irradiate positions displaced by one pixel in the main scanning direction.

Preferably, the control unit controls each of the plurality of laser units to match the write-start position of the laser beam emitted from the another laser light source with the reference write-start position of a laser beam emitted from the reference laser light source, by the another laser light source irradiating a position delayed by a displaced pixel in the scanning direction with respect to a laser beam emitted from the reference laser light source, at a timing delayed by the displaced pixel from the reference laser light source.

Preferably, the control unit performs timing control of laser light sources by generating a synchronous clock based on a detected result of a laser beam emitted from the reference laser light source, to match the write-start position of the laser beam emitted from the another laser light source with the reference write-start position of a laser beam emitted from the reference laser light source.

Preferably, the plurality of laser light sources comprise three or more laser light sources, and a main displacement is used as the displacement of the plurality of laser beams, the main displacement being calculated based on an inclination of a line which is obtained with a least square method when the plurality of light sources after compensation of the inclined arrangement to vertical arrangement are plotted as dots on a virtual plane.

Preferably, the laser unit comprises the plurality of laser light sources with vertical arrangement such that the plurality of laser beams irradiate the same position in the main scanning direction.

Preferably, the plurality of laser light sources comprise three or more laser light sources, and a main displacement is used as the displacement of the plurality of laser beams, the main displacement being calculated based on an inclination of a line which is obtained with a least square method when the plurality of light sources with vertical arrangement are plotted as dots on a virtual plane.

Preferably, each of a plurality of image forming units is provided with one of the plurality of laser units, to form a single-colored color image.

Preferably, each of the plurality of image forming units includes a photosensitive drum, wherein each of the plurality of laser units scans the photosensitive drum with laser beams to form an electrostatic latent image.

Preferably, each of the plurality of image forming units includes a charging unit to charge the photosensitive drum, and a developing unit to adhere a toner onto the photosensitive drum, and wherein the charging unit charges the drum, the laser unit forms the latent image on the photosensitive drum, the developing unit adheres the toner onto the latent image, and the toner image is pressed on a recording sheet and transferred onto the recording sheet to form a color image.

### BRIEF DESCRIPTION OF THE DRAWINGS

The present invention will become more fully understood from the detailed description given hereinafter and the accompanying drawings, and these are not intended to limit the present invention, and wherein:

FIG. 1 is a schematic view showing main parts of the structure of an image forming apparatus according to an embodiment of the invention;

FIG. 2 is a schematic view showing the structure of an image forming unit according to the embodiment;

FIG. 3 is a schematic view showing the structure of a laser unit according to the embodiment;

FIG. 4 is a block diagram showing a control structure of a control unit according to the embodiment;

FIG. 5 is a flowchart showing a process procedure of determining reference-beam selection signals in the control unit;

FIG. 6A is a view illustrating a color displacement in the image forming apparatus according to the embodiment, under the conditions that a first and second laser light sources are displaced to each other by +⅓ pixel in black and +⅔ pixel in magenta;

FIG. 6B is a view illustrating a color displacement in the image forming apparatus according to the embodiment, under the conditions that the first and second laser light sources are displaced to each other by +⅓ pixel both in black and magenta;

FIG. 6C is a view illustrating a color displacement in the image forming apparatus according to the embodiment, under the conditions that the first and second laser light sources are displaced to each other by +⅓ pixel in black and not displaced in magenta;

FIG. 6D is a view illustrating a color displacement in the image forming apparatus according to the embodiment, under the conditions that the first and second laser light sources are displaced to each other by +⅓ pixel in black and −⅓ pixel in magenta;

FIG. 6E is a view illustrating a color displacement in the image forming apparatus according to the embodiment, under the conditions that the first and second laser light sources are displaced to each other by +⅓ pixel in black and −⅔ pixel in magenta;

FIG. 7 is a view illustrating a state in which a second laser light source is displaced in a main scanning direction by +⅓ pixel relative to a first laser light source;

FIG. 8A is a view illustrating a color displacement in a conventional image forming apparatus under the conditions that a first and second laser light sources are displaced to each other by +⅓ pixel in black and +⅔ pixel in magenta;

FIG. 8B is a view illustrating a color displacement in the conventional image forming apparatus under the conditions that the first and second laser light sources are displaced to each other by +⅓ pixel both in black and magenta;

FIG. 8C is a view illustrating a color displacement in the conventional image forming apparatus under the conditions that the first and second laser light sources are displaced to each other by +⅓ pixel in black and not displaced in magenta;

FIG. 8D is a view illustrating a color displacement in the conventional image forming apparatus under the conditions that the first and second laser light sources are displaced to each other by +⅓ pixel in black and −⅓ pixel in magenta; and

FIG. 8E is a view illustrating a color displacement in the conventional image forming apparatus under the conditions that the first and second laser light sources are displaced to each other by +⅓ pixel in black and −⅔ pixel in magenta.

### PREFERRED EMBODIMENT OF THE INVENTION

Hereinafter, an embodiment of an image forming apparatus according to the invention will be described with reference to the drawings.

The image forming apparatus 1 according to the embodiment is used as, for example, a color copier, a color printer or the like, and includes, as shown in FIG. 1, a plurality of color image forming units 2A, 2B, 2C and 2D, intermediate transfer belt 3, detecting part 4, transfer rollers 5 and fixing unit 6.

The image forming units 2A-2D correspond, in the embodiment, to respective colors of black (K), cyan (C), magenta (M) and yellow (Y), and are disposed spaced apart from each other by a predetermined distance along the intermediate transfer belt 3. The intermediate transfer belt 3 is an endless belt acting as an image bearing part, and toner images, which are developed on photosensitive drums 10A-10D of respective image forming units' 2A-2D, are transferred thereon.

The detecting part 4, having a photo sensor or the like, is disposed at a position where it is possible to detect a test pattern for detecting a positional displacement formed on the intermediate transfer belt 3, and outputs a detection signal of the detected pattern to a control unit to be explained later. The number of the detecting part 4 is determined appropriately. The intermediate transfer belt 3 is inserted through between the transfer rollers 5 and 5 together with a recording sheet P. The toner images, which are transferred from the photosensitive drums 10A-10D to the intermediate transfer belt 3, are transferred onto the recording sheet P with a pressure by the transfer rollers 5 and 5.

At the downstream side of the transfer rollers 5 in a recording-sheet transporting direction, there is provided the fixing unit 6 including a heating roller 61 and a pressing roller 62. The heating roller 61 and the pressing roller 62 of the fixing unit 6 heats the recording sheet P transported between them and press the sheet with a nip pressure to fix the toner image on the recording sheet P. Then, the recording sheet P is discharged from the apparatus by discharge rollers and the like, not shown, at the downstream side of the fixing unit.

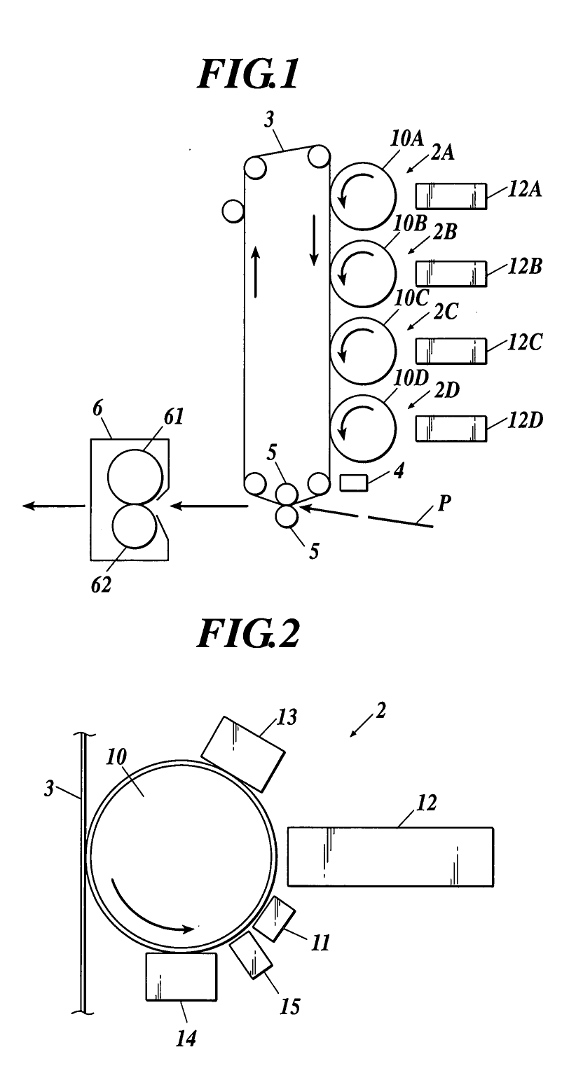

The plurality of image forming units 2A-2D have the same structure, and therefore will be described hereinafter as an image forming unit 2 for an explanation convenience. The image forming unit 2 includes, as shown in FIG. 2, photosensitive drum 10, charging unit 11 that charges the photosensitive drum 10, laser unit 12 that scans the photosensitive drum 10 with laser beams to form an electrostatic latent image, developing unit 13 that adheres toner onto the photosensitive drum 10, cleaner 14 that cleans residual toner on the surface of the photosensitive drum 10, and charge eliminating unit 15 that eliminates the charge on the surface of the photosensitive drum 10.

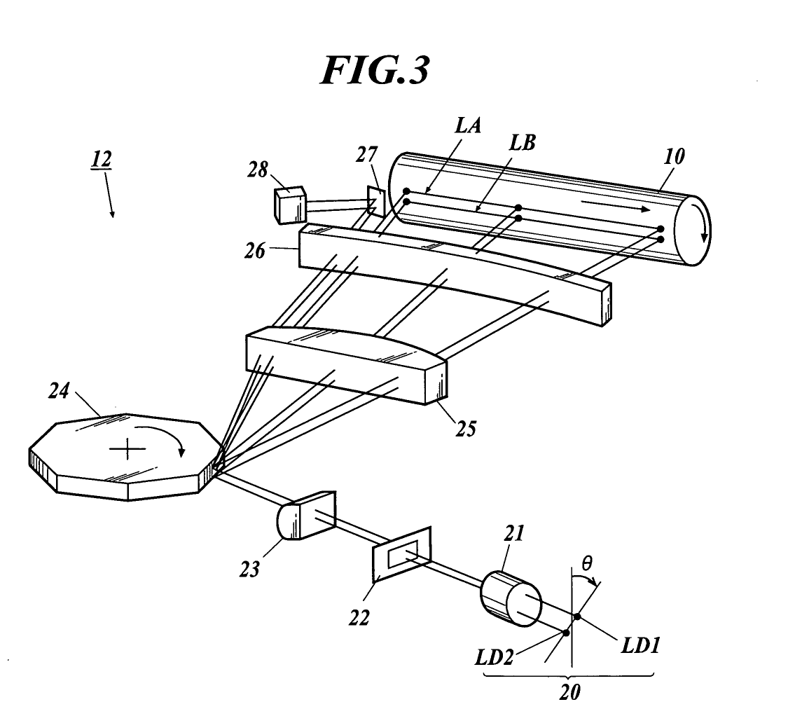

The laser unit 12 irradiates a plurality of laser beams on the photosensitive drum 10 to simultaneously scan a plurality of scanning lines in the main scanning direction for writing onto the drum. As shown in FIG. 3, the laser unit 12 includes light source unit 20, collimator lens 21, slit 22, cylindrical lens 23, polygon mirror 24, fθ lens 25, cylindrical lens 26, mirror 27, and light receiving sensor 28.

The light source unit 20 includes a laser array having a first laser light source LD1 and a second laser light source LD2. In the embodiment, these two laser light sources LD1 and LD2 are arranged at an angle .theta. to the sub-scanning direction, constituting the inclined arrangement. The mirror 27 and the light receiving sensor 28 are located at positions displaced from an image forming area on the photosensitive drum 10.

Irradiation of laser beams from the laser unit 12 onto the photosensitive drum 10 is performed as follows. First, two laser beams emitted from the first laser light source LD1 and the second laser light source LD2, respectively, are collimated by the collimator lens 21. The transmission of the two beams which passed through the collimator lens 21 is restricted by the slit 22 for shaping a beam spot on the photosensitive drum 10.

The two beams which passed through the slit 22 are focused onto a mirror surface of the rotating polygon mirror 24 by the cylindrical lens 23 and are reflected from the mirror surface. Resultantly, the two light beams are deflected. The reflecting mirror surface of the polygon mirror 24 can be regarded as a virtual light source. The distance from the virtual light source to the surface of the photosensitive drum 10 varies depending on the direction of the reflecting mirror surface, so that the influence of the light beams emitted from the virtual light source on a main scanning speed is compensated for by the fθ lens 25.

The two light beams which passed through the fθ lens 25 are focused on the photosensitive drum 10 by the cylindrical lens 26. The two light beams focused on the photosensitive drum 10 scan along scanning lines LA and LB, respectively, shown in FIG. 3. Parts of the two light beams reflected by the polygon mirror 24 are reflected by the mirror 27 and detected by the light receiving sensor 28.

In the image forming apparatus 1 including the laser unit 12 shown in FIG. 3, the rotation of the polygon mirror 24 performs scanning exposure in the main scanning direction and the rotation of the photosensitive drum 10 performs the sub-scanning operation, whereby image formation is carried out. In the embodiment, as described before, the first laser light source LD1 and the second laser light source LD2 of the light source unit 20 are arranged at an angle θ to the sub-scanning direction, constituting the inclined arrangement, and the laser beam irradiating the photosensitive drum 10 from the second laser light source LD2 of the laser unit 12 is displaced by one pixel in the main scanning direction relative to the beam emitted from the first laser light source LD1.

In FIG. 3, the polygon mirror 24 having eight mirror surfaces is used as a scanner for scanning in the main scanning direction by using the two laser beams which passed through the slit 22. However, the number of mirror surfaces of the scanner is not particularly restricted to this example. The light source unit 20 may include two semiconductor laser units, each having one laser light source.

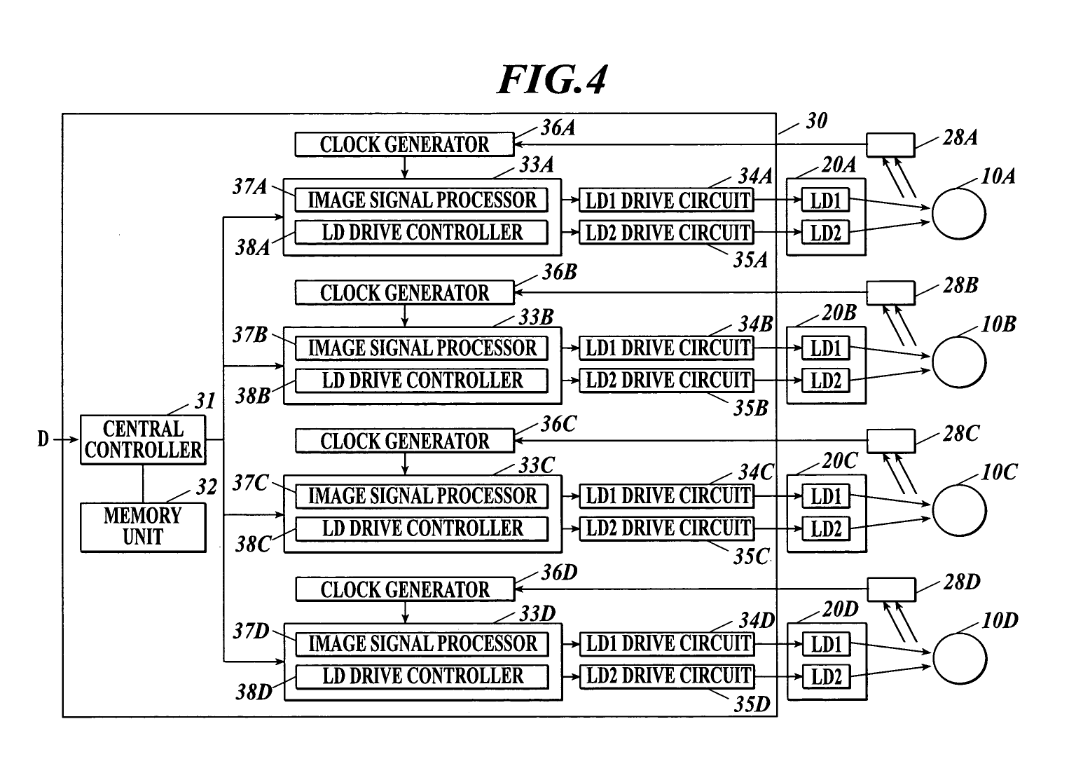

A control unit 30 of the image forming apparatus 1 according to the embodiment, as shown in FIG. 4, includes central controller 31 having a CPU, memory unit 32 having a RAM and a ROM, respective controllers 33A-33D provided corresponding to the laser units 12A-12D of respective image forming units 2A-2D, LD1 drive circuits 34A-34D and LD2 drive circuits 35A-35D for driving respective first and second laser light sources LD1 and LD2 of the laser units 12A-12D, and clock generators 36A-36D.

The central controller 31 transmits image data D, which are sent from, e.g., a host computer, to the respective controllers 33A to 33D.

The respective controllers 33A to 33D include image signal processors 37A to 37D and LD drive controllers 38A to 38D, respectively. The image signal processors 37A-37D generate drive signals for ON/OFF control of the first and second laser light sources LD1 and LD2, based on image data D sent from the central controller 31.

Each of the LD drive controllers 38A-38D inputs to each of the light receiving sensors 28A-28D only a laser beam emitted from a laser light source to be a reference (hereinafter, referred to as a “reference laser source”) selected by the central controller 31 out of two laser beams emitted from the first and second laser light sources LD1 and LD2, the receiving sensors 28A-28D enabling the clock generators 36A-36D to generate respective synchronous clocks, and performs timing control of the other laser light source so that the write-start position of the laser beam matches to that of the other laser beam.

The LD drive controllers 38A-38D also determine the write-start positions of the two laser beams based on the clocks generated by respective clock generators 36A-36D, and distribute and send drive signals, produced by the image signal processors 37A-37D in synchronism with respective synchronous clocks, to the LD1 drive circuits 34A-34D and the LD2 drive circuits 35A-35D.

As described above, in the embodiment, the first laser light sources LD1 and the second laser light sources LD2 of the light source units 20A-20D are arranged at an angle θ to the sub-scanning direction, constituting the inclined arrangement, respectively, and therefore the laser beam irradiating each of the photosensitive drums 10A-10D from the second laser light source LD2 is delayed by one pixel in the main scanning direction relative to the beam emitted from the first laser light source LD1. Accordingly, the image signal processors 37A-37D produce drive signals such that the second laser light source LD2 emits a laser beam in a timing delayed by one pixel from the first laser light source LD1.

The LD1 drive circuits 34A-34D and the LD2 drive circuits 35A-35D generate respective drive voltages based on drive signals sent from respective controllers 33A-33D to apply the voltages to the first and second laser light sources LD1 and LD2. The light source units 20A-20D of respective laser units 12A-12D activate the first and second laser light sources LD1 and LD2 according to the drive voltages applied from the LD1 drive circuits 34A-34D and the LD2 drive circuits 35A-35D to emit respective laser beams.

As shown in FIG. 3, a part of the laser beam emitted from a reference laser source, selected from the first laser light source LD1 or the second laser light source LD2, is reflected by each of the mirrors 27A-27D and detected by the light receiving sensor 28A-28D. As shown in FIG. 4, the detected results of light receiving sensor 28A-28D are input to the clock generators 36A-36D, respectively, to generate synchronous clocks based on the detected results of respective reference laser sources.

The memory unit 32 of the control unit 30 stores in advance the innate displacements of respective laser units 12A-12D, each innate displacement being a displacement of the laser beam emitted from the second laser light source LD2 relative to the laser beam emitted from the first laser light source LD1, which is within one pixel in the main scanning direction and measured at the time of shipping. Incidentally, the displacement in the vertical arrangement represents right a displacement of laser beams emitted from the first and second laser light sources LD1 and LD2, and that in the inclined arrangement as in the embodiment represents a displacement in the main scanning direction after compensation of delaying by one pixel. The innate displacements of these units may be measured when the units are installed.

The central controller 31 of the control unit 30 selects either of the first and second laser light sources LD1 and LD2 as a reference laser source that defines a reference for matching the write-start position for each of four laser units 12A-12D, and sends the results as reference-beam selection signals to the LD drive controllers 38A-38D of respective controllers 33A-33D.

In the embodiment, the central controller 31 reads out innate displacements of respective laser units 12A-12D from the memory unit 32, and based on respective displacement, selects as the reference laser source the same laser light source as the reference laser source of a particular laser unit when the plus/minus of the displacement of each of the laser units 12A-12D is the same as of the displacement in the particular laser unit that is a reference unit for adjustment of color displacement of a color image. On the contrary, when the plus/minus of the displacement of each of the laser units 12A-12D is different from that of the displacement in the particular laser unit, the controller 31 selects as the reference laser source a different laser light source from the reference laser source of the particular laser unit. The central controller 31 determines respective reference-beam selection signals based on the selected reference laser sources.

The actions of the image forming apparatus 1 according to the embodiment will now be described. The description below will be given on the premise that the black (K) laser unit is a reference laser unit for adjustment of color displacement of a color image.

When the apparatus is set up or a unit is exchanged, the central controller 31 of the control unit 30 selects in advance either of the first and second laser light sources LD1 and LD2 as a reference laser source that defines a reference for matching the write-start position for each of the laser units 12A-12D, following the flowchart shown in FIG. 5.

The central controller 31 reads out respective innate displacements in the main scanning direction of the laser units 12A-12D from the memory unit 32 (step S1). When a user selects, for example, the black (K) laser unit as a particular laser unit (“YES” at step S2), it is determined whether the innate displacement of the black (K) laser unit is a positive value or a negative value. When the displacement is a positive value or zero, the controller 31 selects the first laser source LD1 as a reference laser source, and determines the reference-beam selection signal, for example, to be 1. When the displacement is a negative value, the controller 31 selects the second laser source LD2 as a reference laser source, and determines the reference-beam selection signal, for example, to be 2 (step S3). Hereinafter, the displacement value 0 is determined to be a positive value.

Subsequently, when reference-beam selection signals for all other laser units are not determined (“NO” at step S4), then when, for example, the cyan (C) laser unit has the same plus/minus of displacement as that of the particular laser unit, namely, black (K) laser unit (“YES” at step S5), the central controller 31 selects the first laser source LD1 as a reference laser source for the cyan (C) laser unit as in the black (K) laser unit, and determines the reference-beam selection signal to be 1 (step S6).

When the plus/minus of displacement in the cyan (C) laser unit is different from that in the black (K) laser unit (“NO” at step S5), then the central controller 31 selects the second laser source LD2 as a reference laser source for the cyan (C) laser unit, different from the black (K) laser unit, and determines the reference-beam selection signal to be 2 (step S7).

Similarly, for the other laser units of magenta (M) and yellow (Y), the central controller 31 selects reference laser sources and determines reference-beam selection signals, respectively.

Thus, when reference laser sources are selected and reference-beam selection signals are determined for all laser units 12A-12D (“YES” at step S4), the central controller 31 sends the determined reference-beam selection signals to the respective controller 33A-33D (step S8), and ends the process of determining reference-beam selection signals.

When respective reference laser sources are selected for the laser units 12A-12D in an above-described manner and the black (K) laser unit has, for example, a displacement of +⅓ pixel in the main scanning direction as shown in FIG. 7, while the reference laser source of the black (K) laser unit is the first laser light source LD1, the reference laser source of the magenta (M) laser unit is the first laser light source LD1 when the displacement is a positive value or zero, and the second laser light source LD2 when the displacement is a negative value.

Accordingly, when the displacement of the magenta (M) laser unit is a positive value or zero, the write-start positions of the first laser light sources LD1 of both black (K) and magenta (M) laser units are positioned so as to match to each other, and when the displacement of the magenta (M) laser unit is a negative value, the write-start position of the second laser light source LD2 of the magenta (M) laser unit is positioned so as to match to that of the first laser light source LD1 of the black (K) laser unit.

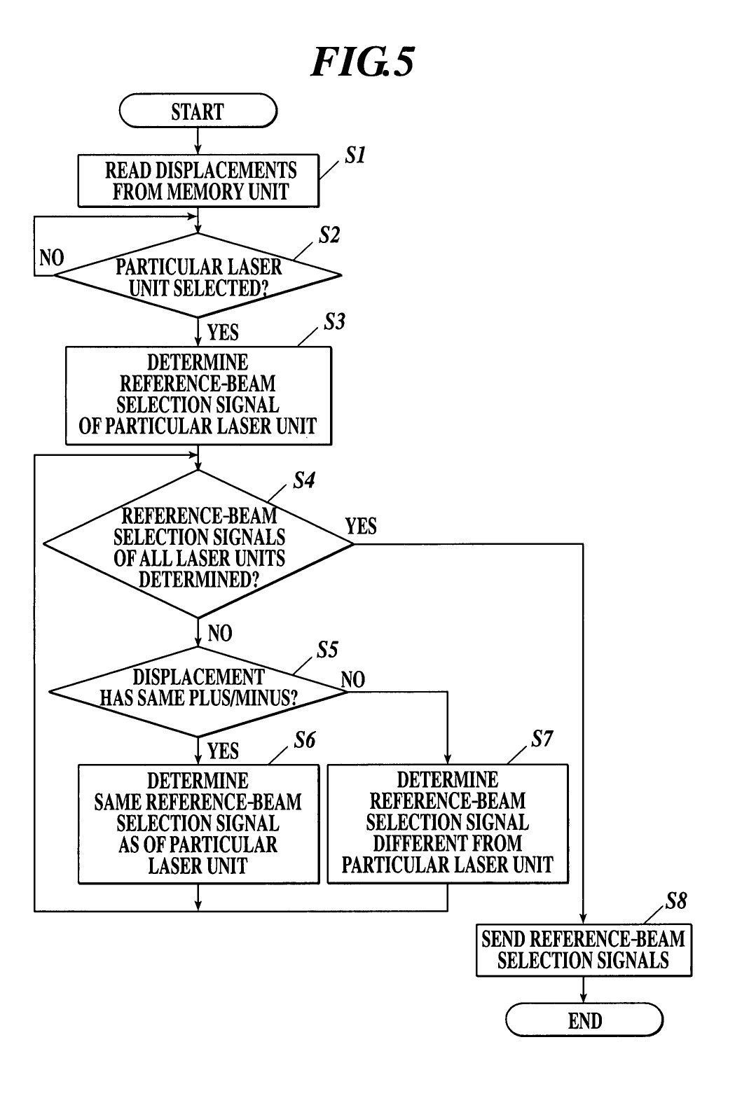

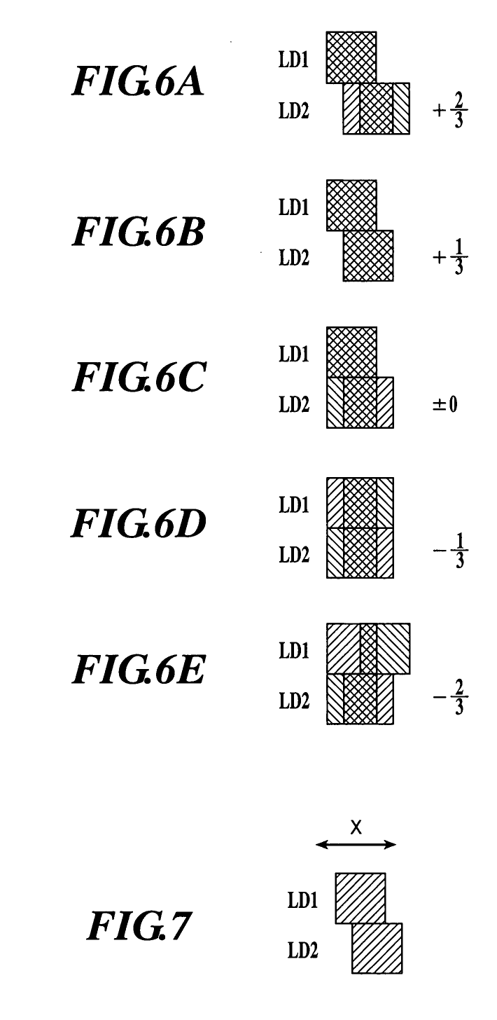

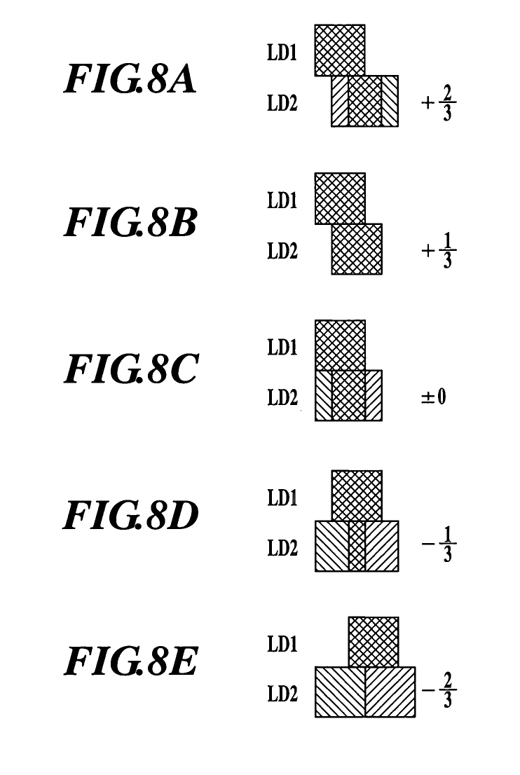

As a result, when the displacement of the magenta (M) laser unit is a positive value or zero, color displacements shown in FIGS. 6A to 6C occur as in FIGS. 8A to 8C. However, as shown in FIGS. 6D and 6E, when the displacement of the magenta (M) laser unit is a negative value, as can be understood in comparison with the cases shown in FIGS. 8D and 8E, the color displacement between black (K) and magenta (M) is dispersed on the scanning line scanned by the first laser light source LD1 as well as the scanning line scanned by the second laser light source LD2, and the maximum width of the color displacement is reduced. In FIGS. 6A to 6E, numbers written at the right side indicate various innate displacements of the magenta (M) unit.

As described above, according to the image forming apparatus 1 of the embodiment, the laser light source as a reference for matching the write-start positions to each other is not restricted, for example, to the first laser light sources as in a conventional apparatus, and the laser light source as a reference for matching the write-start positions to each other is selected in advance for every laser unit of all colors. This selection allows dispersion of the color displacement onto respective scanning lines scanned by the first and second laser light sources while the first laser light source LD1 and the second laser light source LD2 are synchronized with the normal clock, and allows reduction of the maximum width of the color displacement.

Further, the apparatus of the invention, different from a conventional image forming apparatus, is not newly provided with a PLL or a delay circuit for compensating the displacement of less than one pixel in the main scanning direction which causes a control circuit to be complicated, or not newly provided with an adjusting part for adjusting the inclination angle of a laser array and a control circuit thereof, and allows image formation without a remarkable color displacement by using the existing control circuit synchronized with the clock.

Furthermore, the apparatus does not require the installation of a PLL and a delay circuit, or an adjusting part, therefore can be prevented from becoming unnecessarily more expensive.

When the plurality of laser light sources in the laser unit of the image forming apparatus are arranged with the inclined arrangement or the vertical arrangement, the above-described effects can be achieved appropriately for both arrangements.

Further, when a displacement of the plurality of laser light sources included in a laser unit is a same displacement direction between laser units, the same laser light sources are used as references to match the write-start positions to each other to thereby reduce the color displacement, and when displaced in a different displacement direction, a different laser light source is used as a reference to match the write-start positions to each other to thereby reduce the color displacement. This allows achieving the above-described effects more appropriately.

The above description is also applicable to the vertical arrangement of a laser array similarly to the inclined one.

When three or more laser light sources are used, a main displacement may be used as the displacement, the main displacement being calculated based on an inclination of a line which is obtained with a method of least square when light sources of vertical arrangement or inclined arrangement after compensation are plotted as dots on a virtual plane.

The entire disclosure of Japanese Patent Application No. 2006-190777 filed on Jul. 11, 2006, including description, claims, drawings and summary are incorporated herein by reference in its entirety.

What is claimed is:

1. An image forming apparatus to form a color image by using a plurality of laser units, each simultaneously scanning a plurality of scanning lines in a main scanning direction to write with laser beams emitted from a plurality of laser light sources, comprising:
a control unit to control each of the plurality of laser units, which includes a reference laser light source and another laser light source, such that, while the plurality of laser light sources are synchronized with a clock, a write-start position of a laser beam emitted from the another laser light source is matched with a reference write-start position of a laser beam emitted from the reference laser light source,
wherein the control unit selects in advance the reference laser light source in every laser units, based on a previously measured displacement between the plurality of laser beams in each of the laser units.

2. The image forming apparatus of claims 1, wherein, when a plus/minus of the displacement in each of the laser units is the same as that of a displacement in a particular laser unit which is a reference unit for adjustment of a color displacement in a color image, based on the previously measured displacement of the laser beams in each of the laser units, the control unit selects in advance the same laser light source as the reference laser light source of the particular laser unit, as the reference laser light source, and when a plus/minus of the displacement in the laser unit is different from that of a displacement in a particular laser unit selected from the plurality of laser units, the control unit selects in advance a laser light source different from the reference laser light source of the particular laser unit, as the reference laser light source.

3. The image forming apparatus of claim 1, wherein the displacement between the plurality of laser beams in each of the laser units is an innate displacement of each laser unit.

4. The image forming apparatus of claim 3, wherein the innate displacement of each laser unit is a displacement of less than one pixel in the main scanning direction of laser beams emitted from the plurality of laser light sources in the each laser unit.

5. The image forming apparatus of claim 1, wherein the control unit includes a memory unit which stores in advance displacement data of less than one pixel in the main scanning direction of a laser beam emitted from the another laser light source.

6. The image forming apparatus of claim 5, wherein the control unit reads out from the memory unit the displacement data for each laser unit and selects in advance the reference laser light source based on the displacement data.

7. The image forming apparatus of claim 1, wherein the laser unit comprises the plurality of laser light sources with inclined arrangement such that the plurality of laser beams irradiate positions displaced in the main scanning direction in a pixel unit.

8. The image forming apparatus of claim 7, wherein the plurality of laser light sources comprise two laser light sources.

9. The image forming apparatus of claim 8, wherein the control unit controls each of the plurality of laser units to match the write-start position of the laser beam emitted from the another laser light source with the reference write-start position of a laser beam emitted from the reference laser light source, by the another laser light source irradiating a position delayed by a displaced pixel in the scanning direction with respect to a laser beam emitted from the reference laser light source, at a timing delayed by the displaced pixel from the reference laser light source.

10. The image forming apparatus of claim 8, wherein the laser unit comprises the plurality of laser light sources with inclined arrangement such that the two laser light sources irradiate positions displaced by one pixel in the main scanning direction.

11. The image forming apparatus of claim 10, wherein the control unit controls each of the plurality of laser units to match the write-start position of the laser beam emitted from the another laser light source with the reference write-start position of a laser beam emitted from the reference laser light source, by the another laser light source irradiating a position delayed by a displaced pixel in the scanning direction with respect to a laser beam emitted from the reference laser light source, at a timing delayed by the displaced pixel from the reference laser light source.

12. The image forming apparatus of claim 1, wherein the control unit performs timing control of laser light sources by generating a synchronous clock when a laser beam is emitted from the reference laser light source, to match the write-start position of the laser beam emitted from the another laser light source with the reference write-start position of a laser beam emitted from the reference laser light source.

13. The image forming apparatus of claim 7, wherein the plurality of laser light sources comprise three or more laser light sources, and a main displacement is used as the displacement of the plurality of laser beams, the main displacement being calculated based on an inclination of a line which is obtained with a least square method when the plurality of light sources after compensation of the inclined arrangement to vertical arrangement are plotted as dots on a virtual plane.

14. The image forming apparatus of claim 1, wherein the laser unit comprises the plurality of laser light sources with vertical arrangement such that the plurality of laser beams irradiate the same position in the main scanning direction.

15. The image forming apparatus of claim 14, wherein the plurality of laser light sources comprise three or more laser light sources, and a main displacement is used as the displacement of the plurality of laser beams, the main displacement being calculated based on an inclination of a line which is obtained with a least square method when the plurality of light sources with vertical arrangement are plotted as dots on a virtual plane.

16. The image forming apparatus of claim 1, wherein each of a plurality of image forming units is provided with one of the plurality of laser units, to form a single-colored color image.

17. The image forming apparatus of claim 16, wherein each of the plurality of image forming units includes a photosensitive drum, wherein each of the plurality of laser units scans the photosensitive drum with laser beams to form an electrostatic latent image.

18. The image forming apparatus of claim 17, wherein each of the plurality of image forming units includes a charging unit to charge the photosensitive drum, and a developing unit to adhere a toner onto the photosensitive drum, and wherein the charging unit charges the drum, the laser unit forms the latent image on the photosensitive drum, the developing unit adheres the toner onto the latent image, and the toner image is pressed on a recording sheet and transferred onto the recording sheet to form a color image.
